(19) United States
(12) Patent Application Publication
(10) Pub. No.: US 2025/0078075 A1
(43) Pub. Date: Mar. 6, 2025

(54) METHOD FOR VERIFICATION OF HARDWARE-BASED AND SOFTWARE-BASED PAYMENT TERMINAL AUTHENTICITY DURING CARDHOLDER VERIFICATION

(71) Applicant: Visa International Service Association, San Francisco, CA (US)

(72) Inventors: John Markh, Burlington (CA); Christian Aabye, San Francisco, CA (US)

(73) Assignee: Visa International Service Association, San Francisco, CA (US)

(21) Appl. No.: 18/820,654

(22) Filed: Aug. 30, 2024

Related U.S. Application Data
(60) Provisional application No. 63/579,797, filed on Aug. 30, 2023.

(51) Int. Cl. G06Q 20/40; G06Q 20/38

(52) U.S. Cl. CPC G06Q 20/4012; G06Q 20/382; G06Q 20/4014

(57) ABSTRACT

A computer-implemented method for authenticating a payment terminal during a payment transaction by a cardholder is disclosed. The computer-implemented method includes receiving payment information associated with a cardholder account of the cardholder. The method further includes transmitting a payment authorization request to an issuer server, receiving a response form the issuer server to the payment authorization request. The response includes a verification request of a personal identification number (PIN) associated with the cardholder account, and a cardholder-recognizable token previously associated with the cardholder account. The method further includes presenting the cardholder-recognizable token to the cardholder with the verification request of the PIN.

### CROSS-REFERENCE TO RELATED APPLICATIONS

This application claims the benefit of and priority under 35 U.S.C. § 119 (e) to U.S. Provisional Application No. 63/579,797, filed Aug. 30, 2023, entitled “METHOD FOR VERIFICATION OF HARDWARE-BASED AND SOFTWARE-BASED PAYMENT TERMINAL AUTHENTICITY DURING CARDHOLDER VERIFICATION,” the contents of which is hereby incorporated by reference in its entirety herein.

### FIELD

At least some aspects of the present disclosure relate to methods, devices, and systems for dynamic verification of hardware-based and/or software-based payment terminal authenticity.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a flow diagram illustrating a method for authenticating a payment terminal, in accordance with at least one aspect of the present disclosure.

FIG. 2 is a terminal authentication system for authenticating a payment terminal, in accordance with at least one aspect of the present disclosure.

FIG. 3 is a payment terminal presenting a token, in accordance with at least one aspect of the present disclosure.

FIG. 4 illustrates a number of token option for cardholder selection, in accordance with at least one aspect of the present disclosure.

FIG. 5 is flow diagram illustrating a method for securing a cardholder-recognizable token, in accordance with at least one aspect of the present disclosure.

FIG. 6 is a flow diagram illustrating a method for authenticating a payment terminal, in accordance with at least one aspect of the present disclosure.

FIG. 7 presents a block diagram of a computer apparatus, according to at least aspect of the present disclosure.

FIG. 8 is a diagrammatic representation of an example system that includes a host machine within which a set of instructions to perform any one or more of the methodologies discussed herein may be executed, according to at least aspect of the present disclosure.

Corresponding reference characters indicate corresponding items throughout the several views. The exemplifications set out herein illustrate various aspects of the present disclosure, in one form, and such exemplifications are not to be construed as limiting the scope of the present disclosure in any manner.

### DETAILED DESCRIPTION

Before explaining various forms of the payment card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

As used herein, a “portable electronic device” may refer to any electronic device that is portable and operated by user. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on. In some embodiments, a portable electronic device constitutes a payment device (e.g., a portable device can store and be able to transmit payment credentials for a transaction).

A “server/server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The terms “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

In the past, strict control over payment terminals and their components (e.g., Personal Identification number (PIN) entry devices) made it difficult for fraudsters to obtain or to build plausible or realistic payment terminals.

However, with evolution and proliferation of 3D printers, availability of used payment terminals for sale on online retail sites, there has been an increase in ability to turn any modern mobile Commercial Off-The-Shelf (COTS) device into a payment acceptance device. Consequently, fraudsters can now easily create a fake payment terminal to scam cardholders/users/customers to harvest account credentials or for relay attacks to use captured account information and PIN on a fake payment terminal to withdraw funds from contactless ATMs or to conduct financial transactions.

To address some of these issues, existing legitimate payment acceptance devices and applications often display payment brand logos (part of sensory branding), or have a checkmark sign, or display an approval number during verification. Nonetheless, a static authenticity token, e.g., a payment brand logo or an evaluation approval number, can be easily obtained by the fraudsters, and recreated and displayed when creating a malicious terminal. Consequently, whether it is a hardware-based payment terminal or software application running on the mobile COTS device, cardholders or customers have no ability to identify whether the hardware-based device or the software application used for payment acceptance is legitimate or not.

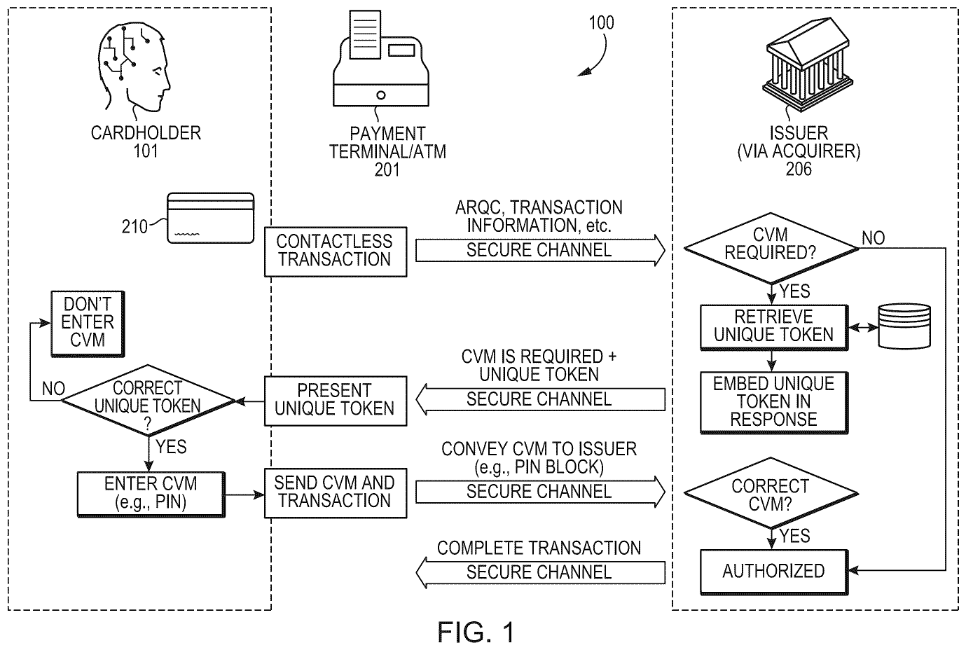

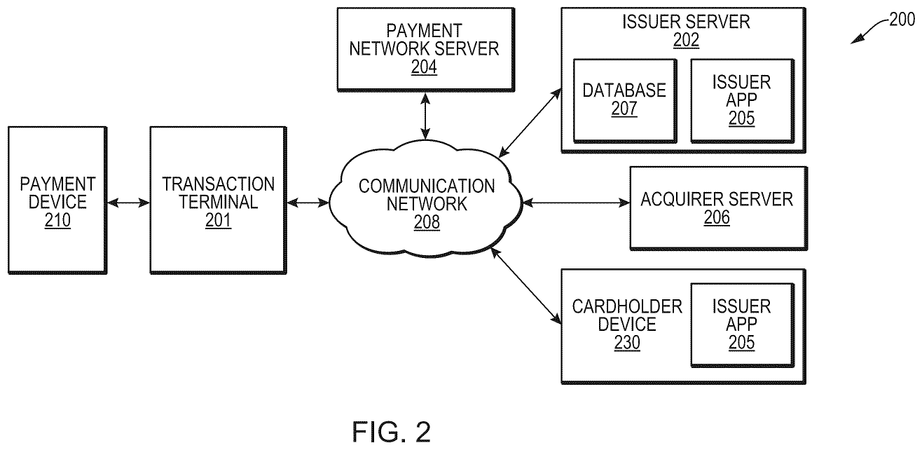

Referring to FIGS. 1 and 2, a method 100 for authenticating a transaction terminal 201 during a payment transaction, for example, and an authentication system 200 to implement the method 100 are illustrated. In some aspects, the system 200 may implement the authentication method 100 during cardholder 101 verification and/or for high value transactions, e.g., transactions greater than or equal to a predetermined threshold. The terminal 201 can be a POS terminal or an Automated Teller Machine (ATM), for example, through which a financial transaction, e.g., a payment transaction, can be performed.

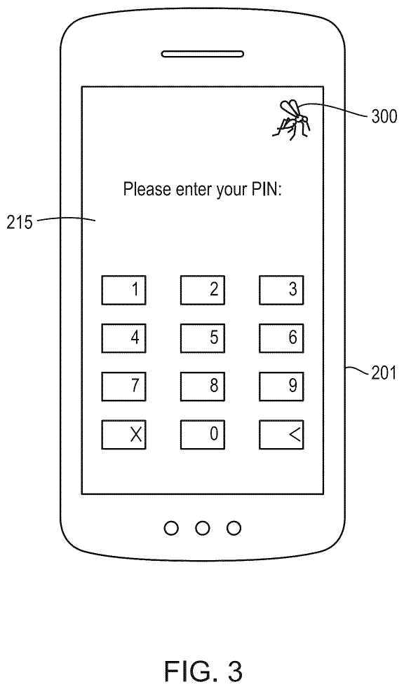

To protect against fraudulent payment terminals, the system 200, implementing the method 100, utilizes a unique customer-recognizable token 300 (FIG. 3) to assure the cardholder 101 of the authenticity of a payment terminal 201. Failure to present the token 300 alerts the cardholder 101 to fraudulent activities. In some aspects, the cardholder 101 preselects the token 300 to be associated with a payment card and/or to be associated with the cardholder 101. The token 300 may be chosen by the cardholder 101 in a payment card personalization procedure, for example.

The system 200 includes an issuer server 202 that facilitates token selection by a cardholder 101 during an initial onboarding, for example. The issuer server 202 may present the token 300 to the cardholder 101, or allow the cardholder 101 to select the token 300 from a plurality of available tokens, for example. In some aspects, the cardholder 101 is permitted to create their own token that is then transmitted to the issuer server 202. An issuer interface such as, for example, an issuer application 205 can be utilized to obtain/identify/select the token 300. The issuer server 202 then stores the token 300, or any suitable indication of the cardholder selection, in a database 207, for example. In some instances, the database 207 may be configured to store information related to the cardholder 101, and unique tokens 300 associated with and/or selected by the cardholder 101.

In some aspects, the system 200 may further include a payment network 204 and an acquirer 206. The token 300 selection/identification can be facilitated by the payment network 204, for example, in a similar manner described with respect to the issuer server 202.

Various components of the system 200 perform various interactions facilitated by a communication network 208, for example. As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit can directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction.

Referring still to FIGS. 1 and 2, the method 100 includes receiving, by the terminal 201, payment information associated with the cardholder account of the cardholder 101. The cardholder 101 may utilize any suitable payment device 210 to interact with the terminal 201.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computer (e.g. tablet or laptop computer), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some non-limiting embodiments, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like.

Further to the above, the method 100 includes transmitting, by the terminal 201, a payment authorization request to the issuer server 202. The payment authorization request can be transmitted through the communication network 208, for example, and can include payment information, transaction information, and/or any information needed for securing payment authorization. In some aspects, the payment authorization request is routed to the issuer server 202 through the acquirer server 206, for example.

The method 100 further includes receiving, by the terminal 201, a response form the issuer server 202 to the payment authorization request. The response includes a verification request of a personal identification number (PIN) associated with the cardholder account, and a cardholder-recognizable token 300 previously associated with the cardholder account. As illustrated in FIG. 3, the token 300 can be presented on a display generation component 215 of the terminal 201, for example, thereby allowing the cardholder 101 to authenticate the terminal 201. In the illustrated example, the token 300 is presented along with the verification request of the PIN. In other instances, the token 300 can be presented separately.

The token 300 may include, for example, an image, a text, a symbol, a sound, an audio recording, and/or any cardholder-recognizable gesture that enables the cardholder 101 to verify authenticity of the terminal 101. For example, if the cardholder 101 selects a mosquito as a unique token, the same image must be displayed on the payment terminal 103 during the transaction, as shown in FIG. 3. In this manner, the customer 101 may verify the authenticity of the payment terminal 201.

In one implementation, the token 300 is an audio recording previously-recorded by the cardholder, for example. In such implementation, an issuer application 205, for example, can prompt the cardholder to record message for utilization as the token 300. The audio message can be stored by the issuer server 202, and can be transmitted to the terminal 201, through the communication network 208, for presentation by the terminal 201 to the cardholder 101 to assure authenticity of the terminal 201.

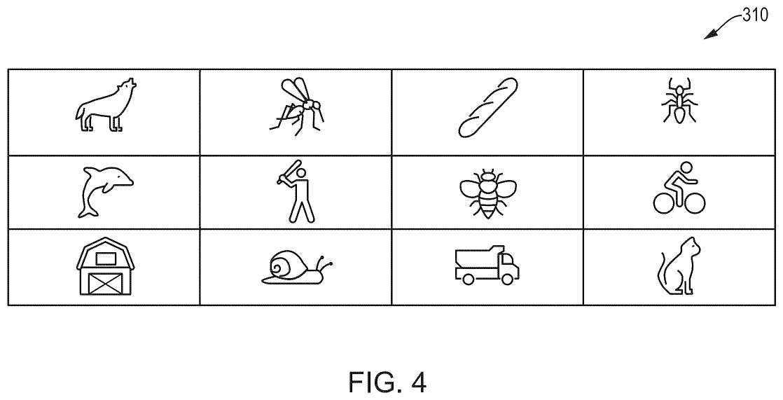

In some aspects, the cardholder 101 may select the unique token 300 for performing authentication of the terminal 201 while initiating a transaction. In some aspects, the unique token 300 may be selected by the cardholder 101 as part of personalization of the payment card with the issuer. During the personalization of the payment card, for example, while confirming an address, contact details, and selecting a security PIN for the payment card, the cardholder 101 is presented with an option to select the unique token 300. Alternatively, the cardholder 101 may select the unique token 300 at any given point time via the issuer or bank's e-banking system or by visiting an offline branch of the bank. Token selection can be achieved using any suitable technique such as, for example, via an input field, where the cardholder 101 types a memorable text phrase, or via an image grid 310 from which the cardholder 101 selects an image, or a symbol, as illustrated in FIG. 4.

In some aspects, as illustrated in FIG. 1, the token authentication of the terminal 201 is performed in transactions involving a CVM request such as, for example, in transactions that are greater than or equal to a predetermined threshold. The transaction information (including amount of transaction and details of the customer) may be sent to the issuer server 202 to determine whether the CVM is required to be performed for the particular transaction. If the CVM is not required, the transaction will be authorized and the transaction will be completed. On the other hand, if the CVM is required, then the issuer server 202 retrieves the token 300 previously set by the cardholder 101 and stored in the database 207, and embeds the token 300 in a transaction response to be received by the terminal 201.

For example, the transaction response may indicate the token 300 and that the CVM is required. The terminal 201 may be configured to display the indicated token 300 to the cardholder 101. If the cardholder 101 finds that the token 300 is correct and is the one that the cardholder 101 had previously selected for performing the transaction, then the cardholder 101 may enter the security PIN and continue with the regular course of transaction.

The issuer server 206 determines whether the CVM is correct. If it is found that the CVM is correct, the transaction will be authorized from the issuer server 206 end and the transaction will be completed. On the other hand, if there is no token displayed on the terminal 201 and/or when the cardholder 101 finds that the token displayed is incorrect or it does not match with the token previously selected by the cardholder 101, then the cardholder 101 may decline the transaction.

In a non-limiting example, during a card-present payment transaction, the cardholder 101 may be required to verify his/her identity. For example, in a high-risk transaction, or a high value transaction (e.g., a contactless transaction of over a predetermined value) or when the cardholder 101 has done more than a maximum number of consecutive contactless transactions without a CVM, the cardholder 101 may be asked to verify his/her identity. Further, the issuer server 206 may determine that a step-up is required and, in response, may include the unique token 300, previously selected by the cardholder 101, and display it alongside the prompt for CVM on the terminal 201.

In some aspects, the unique token 300 may be stored alongside the other information that the issuer server 206 collects about the cardholder 101 and is connected to the specific payment card used by the cardholder 101. In cases where the card issuer is generating a PIN on behalf of the cardholder (e.g., certain geographical locations) or the cardholder 101 already has a PIN (e.g., replacement of damaged or expired payment card), the issuer server 206 can randomly select a unique token 300 for sending to the cardholder 101 in a tamper-resistant envelop, for example. The cardholder 101 can then choose to change the pre-selected unique token 300.

In some embodiments, in addition to image, symbol, or text tokens, the method can support an audio/voice-based token, as described above. For example, during the personalization of the payment card, the cardholder 101 may audio record a short sentence or select from pre-recorded audio samples. In this manner, with the help of audio or pre-recorded audio samples, visually impaired customers may also be supported.

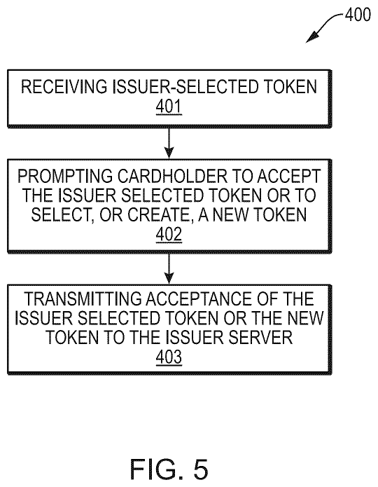

In some aspects, the issuer server 206 is to transmit an issuer-selected token to the issuer application 205 at a cardholder device 230, e.g., a computer device, a tablet, a cell phone. The cardholder 101 may then access the issuer application 205, and select a new token to replace the issuer-selected token. FIG. 5 illustrates a method 400 that can be implemented by the issuer application 401. The method 400 includes receiving 401 the issuer-selected token, for example through the communication network 208, and prompting 402 cardholder 101 to accept the issuer selected token or to select, or create, a new token (e.g., text, image, sound, audio-recording, symbol). The method further includes transmitting 403 acceptance of the issuer selected token or the new token to the issuer server 206.

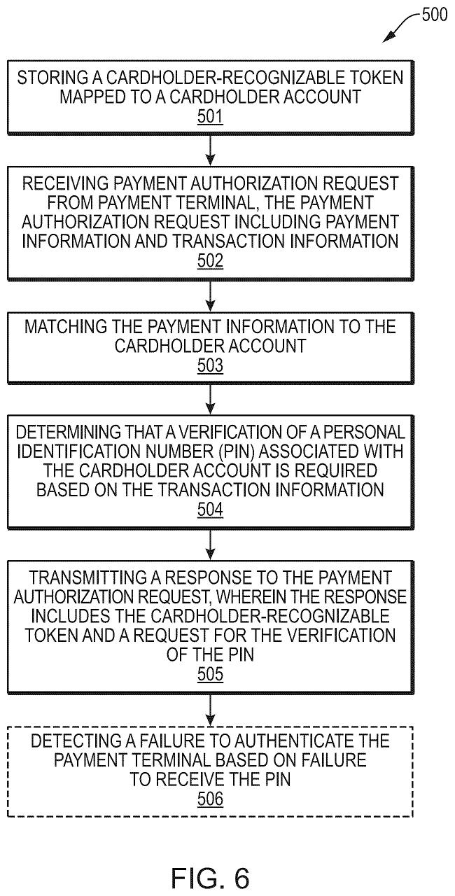

FIG. 6 is a flow diagram illustrating a method 500 that can be implemented by the issuer server 206 for authenticating the payment terminal 201. The method 500 includes storing 501 a cardholder-recognizable token (e.g. selected by issuer server, or selected or created by cardholder 101), wherein the cardholder-recognizable token is mapped to a cardholder account. The method 500 further includes receiving 502 a payment authorization request from the payment terminal 201. The payment authorization request includes payment information and transaction information. The method 500 further includes matching 503 the payment information to the cardholder account, and determining 504 that a verification of a personal identification number (PIN) associated with the cardholder account is required based on the transaction information.

The method 500 further includes transmitting 504 a response to the payment authorization request, wherein the response includes the cardholder-recognizable token and a request for the verification of the PIN. Failure to receive the PIN can be construed as an indication that the payment terminal 201 has been deemed unauthentic by the cardholder 101. Accordingly, the method 500 may further includes detecting 506 a failure to authenticate the payment terminal 201 based on failure to receive the PIN. In response, the issuer server 206 may request input to confirm unauthenticity of the payment terminal.

The input request can be transmitted to the issuer application 205 that may prompt the cardholder 101 to confirm unauthenticity of the payment terminal 201, a failure to receive the token, or a token mismatch. In response to receiving, for example from the issuer application 205, an indication that the payment terminal 201 is unauthentic, the issuer server 206 may assign the suspect payment terminal 201 an unauthentic status, may store information about the suspect payment terminal 201, and/or may block further transactions from the suspect payment terminal 201.

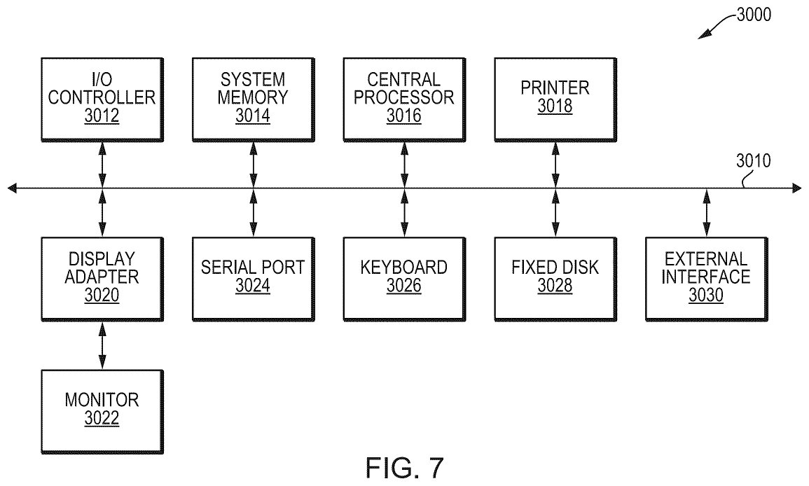

FIG. 7 is a block diagram of a computer apparatus 3000 with data processing subsystems or components, according to at least one aspect of the present disclosure. The subsystems shown in FIG. 7 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

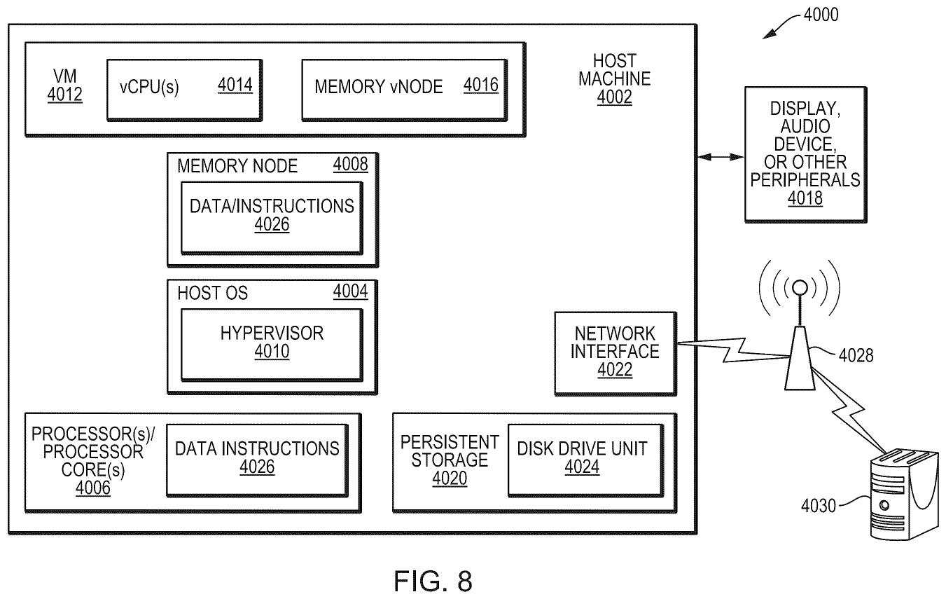

FIG. 8 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible considering the above teachings. The one or more forms were chosen and described to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method for authenticating a payment terminal during a payment transaction by a cardholder, the computer-implemented method comprising:
receiving, by the payment terminal, payment information associated with a cardholder account of the cardholder;
transmitting, by the payment terminal, a payment authorization request to an issuer server;
receiving, by the payment terminal, a response from the issuer server to the payment authorization request, wherein the response comprises:
a verification request of a personal identification number (PIN) associated with the cardholder account; and
a cardholder-recognizable token previously associated with the cardholder account; and
presenting, by the payment terminal, the cardholder-recognizable token to the cardholder with the verification request of the PIN.

2. The computer-implemented method of claim 1, wherein the cardholder-recognizable token is an image previously selected by the cardholder.

3. The computer-implemented method of claim 1, wherein the cardholder-recognizable token is an audio recording previously-recorded by the cardholder.

4. The computer-implemented method of claim 1, wherein the cardholder-recognizable token comprises at least one of a visual pattern or an audio pattern previously-selected by the cardholder.

5. The computer-implemented method of claim 1, wherein presenting the cardholder-recognizable token to the cardholder with the verification request of the PIN comprises:
presenting a numeric keypad on a display of the payment terminal; and
presenting the cardholder-recognizable token with the numeric keypad.

6. The computer-implemented method of claim 5, further comprising:
receiving, by the payment terminal, a value of the PIN through the numeric keypad;
transmitting, by the payment terminal, the value of the PIN to the issuer server; and
receiving, by the payment terminal, an approval of the payment authorization request.

7. The computer-implemented method of claim 1, wherein the payment terminal is a software-based payment terminal.

8. The computer-implemented method of claim 1, wherein the payment terminal is a hardware-based payment terminal.

9. A computer-implemented method for authenticating a payment terminal, the computer-implemented method comprising:
storing, by an issuer server, a cardholder-recognizable token, wherein the cardholder-recognizable token is mapped to a cardholder account;
receiving, by the issuer server, a payment authorization request from the payment terminal, wherein the payment authorization request comprises:
payment information; and
transaction information;
matching, by the issuer server, the payment information to the cardholder account;
determining, by the issuer server, that a verification of a personal identification number (PIN) associated with the cardholder account is required based on the transaction information; and
transmitting, by the issuer server, a response to the payment authorization request, wherein the response comprises:
the cardholder-recognizable token; and
a request for the verification of the PIN.

10. The computer-implemented method of claim 9, further comprising:
selecting, by the issuer server, a token to be the cardholder-recognizable token; and
transmitting, by the issuer server, the token to a cardholder device.

11. The computer-implemented method of claim 10, wherein the cardholder-recognizable token is a token previously-selected or previously-created by the cardholder.

12. The computer-implemented method of claim 10, wherein the cardholder-recognizable token is an image previously selected by the cardholder.

13. The computer-implemented method of claim 10, wherein the cardholder-recognizable token is an audio recording previously-recorded by the cardholder.

14. The computer-implemented method of claim 10, wherein the cardholder-recognizable token comprises at least one of a visual pattern or an audio pattern previously-selected by the cardholder.

15. The computer-implemented method of claim 10, further comprising detecting, by the issuer server, a failure to authenticate the payment terminal based on failure to receive the PIN.

16. The computer-implemented method of claim 10, further comprising assigning, by the issuer server, an unauthentic status to the payment terminal based on failure to receive the PIN.

17. The computer-implemented method of claim 16, further comprising requesting, by the issuer server, input to confirm unauthenticity of the payment terminal.

18. The computer-implemented method of claim 17, wherein requesting the input comprises transmitting a communication to an issuer application on a cardholder device.

19. The computer-implemented method of claim 10, wherein determining that the verification of PIN is required is based on a transaction value in the transaction information meeting or exceeding a predetermined threshold.

20. A computer-implemented method for authenticating a payment terminal during a transaction by a cardholder, the computer-implemented method comprising:
receiving, by the payment terminal, payment information associated with a cardholder account;
transmitting, by the payment terminal, to an issuer server, a payment authorization request including the payment information and transaction information associated with the transaction;
receiving, by the payment terminal, a cardholder-recognizable token and a request for verification of a personal identification number (PIN) associated with the cardholder account;
presenting, by the payment terminal, the cardholder-recognizable token and a numeric keypad for entry of the PIN;
transmitting, by the payment terminal, a user input through the numeric keypad to the issuer server; and
receiving, by the payment terminal, from the issuer server, a payment authorization message.
